(19) United States
(12) Patent Application Publication
(10) Pub. No.: US 2014/0294108 A1
(43) Pub. Date: Oct. 2, 2014

(54) Extrapolating Channel State Information ("CSI") Estimates From Multiple Packets Sent Over Different Antennas to Generate a Combined CSI Estimate for a MIMO-OFDM System

(71) Applicants: Raul Hernan Etkin, Mountain View, CA (US); Jung Gun Lee, Mountain View, CA (US); Sung-Ju Lee, Redwood City, CA (US); Riccardo Crepaldi, Campaign, IL (US)

(72) Inventors: Raul Hernan Etkin, Mountain View, CA (US); Jung Gun Lee, Mountain View, CA (US); Sung-Ju Lee, Redwood City, CA (US); Riccardo Crepaldi, Campaign, IL (US)

(21) Appl. No.: 14/240,511

(22) PCT Filed: Sep. 23, 2011
(86) PCT No.: PCT/US2011/053149

§ 371 Date: Jun. 12, 2014

(51) Int. Cl. H04B 7/06; H04L 27/26

(52) U.S. Cl. CPC H04B 7/0626; H04L 27/2646
USPC 375/267

(57) ABSTRACT

A method for extrapolating channel state information (“CSI”) estimates from multiple packets sent over different antennas to generate a combined CSI estimate for a MIMO-OFDM system is disclosed. Packets are received on m×nᵢ×W channel configurations, wherein m is the number of receive antennas used to receive the packets, nᵢ is the number of transmit antennas used to transmit the packet indexed with i, and W is the number of OFDM channels in the MIMO-OFDM system. CSI estimates are generated for the received packets and the CSI estimates are extrapolated to generate a combined CSI estimate for an m×q×W channel configuration, wherein q>nᵢ for all i.

### CROSS REFERENCE TO RELATED APPLICATIONS

This application is related to U.S. patent application Ser. No. ______ (Attorney Docket No. 700206390WO01), entitled “Extrapolating Channel State Information (“CSI”) Estimates from Multiple Packets Sent Over Different Frequency Channels to Generate a Combined CSI Estimate for a MIMO-OFDM System” filed concurrently herewith and herein incorporated by reference in its entirety.

### BACKGROUND

The deployment of 802.11 Wireless Local Area Networks (“WLANs”) has recently experienced explosive growth as multiple applications and services now demand high throughput networks. One of the key features of high speed WLANs is the use of Multiple Input, Multiple Output (“MIMO”) antenna technology that offers significant increases in data throughput and link range without additional bandwidth or transmit power. Performance improvements are also achieved with the use of Orthogonal Frequency-Division Multiplexing (“OFDM”) modulation to convert a wideband channel into multiple narrowband channels in order to avoid inter-symbol interference (“ISI”).

A MIMO-OFDM channel is described with fine granularity by Channel State Information (“CSI”), which represents the current conditions and properties of the channel. CSI is provided in the 802.11n hardware by analyzing received packets with training sequences in the packet headers. For network algorithms such as rate selection, access point (“AP”) association, channel assignment, etc., to make a timely, optimal decision, accurate CSI estimates under various settings (e.g., different number of spatial streams, transmission antennas used, transmission powers, etc.) must be known. However, some of these settings might not be sampled in recently received packets and additional packet transmissions are required to obtain the complete CSI to accurately characterize the channel. This extra process consumes bandwidth and increases latency, and hence such unnecessary sampling should be avoided.

### BRIEF DESCRIPTION OF THE DRAWINGS

The present application may be more fully appreciated in connection with the following detailed description taken in conjunction with the accompanying drawings, in which like reference characters refer to like parts throughout, and in which:

FIG. 1 illustrates a schematic diagram of a MIMO-OFDM channel model;

FIG. 2 illustrates an example schematic diagram for estimating a 3×2×56 CSI data structure from two packets transmitted using a 3×1×56 configuration;

FIG. 3 illustrates a schematic diagram of a MIMO channel using a precoding matrix Q;

FIG. 4 illustrates an example schematic diagram of operations used to generate a combined 3×3×56 CSI estimate from two packets sent and received with a 3×2×56 channel configuration and a precoding matrix Q₂;

FIG. 5 is a flowchart for estimating the combined 3×3×56 CSI of FIG. 4 using estimates from two packets sent and received with a 3×2×56 channel configuration and a precoding matrix Q₂; and

FIG. 6 is a block diagram of an example receiver computing system for estimating a combined CSI according to the present disclosure.

### DETAILED DESCRIPTION

A receiver, module, and method for extrapolating Channel State Information (“CSI”) estimates from multiple packets sent over different antennas to generate a combined CSI estimate for a MIMO-OFDM system are disclosed. As generally described herein, CSI represents the current conditions and properties of the channel and consists of the attenuation and phase shift experienced by each spatial stream to each receive antenna in each of the OFDM subcarriers. CSI is derived from successfully received packets in 802.11n systems by using training sequences (e.g., pilot sequences) included in the packet's preamble.

In various embodiments, CSI estimates obtained from a small number of packets sent over multiple antennas are extrapolated to derive a combined CSI estimate for a larger number of antennas. The combined CSI estimate represents a channel state that has not been sampled and that is different and larger than the channel states used to send and receive the packets. For example, a combined 2×2×56 CSI estimate may be derived by extrapolating CSI estimates obtained from two packets transmitted using a 2×1×56 configuration, as long as different transmit antennas are used to send the two packets. More generally, a combined CSI estimate may be derived for any m×q×W channel configuration using CSI estimates obtained from packets received with an m×nᵢ×W channel configuration, for nᵢ and q transmit antennas and m receive antennas, where W is the number of OFDM channels used in the system, i denotes the packet index and q>nᵢ. Doing so can enhance the efficiency of various network algorithms such as rate adaptation, antenna selection, and association control and hence improve the overall network performance.

It is appreciated that embodiments described herein below may include various components and features. Some of the components and features may be removed and/or modified without departing from a scope of the receiver, module, and method for extrapolating CSI estimates to generate a combined CSI estimate. It is also appreciated that, in the following description, numerous specific details are set forth to provide a thorough understanding of the embodiments. However, it is appreciated that the embodiments may be practiced without limitation to these specific details. In other instances, well known methods and structures may not be described in detail to avoid unnecessarily obscuring the description of the embodiments. Also, the embodiments may be used in combination with each other.

Reference in the specification to “an embodiment,” “an example” or similar language means that a particular feature, structure, or characteristic described in connection with the embodiment or example is included in at least that one example, but not necessarily in other examples. The various instances of the phrase “in one embodiment” or similar phrases in various places in the specification are not necessarily all referring to the same embodiment.

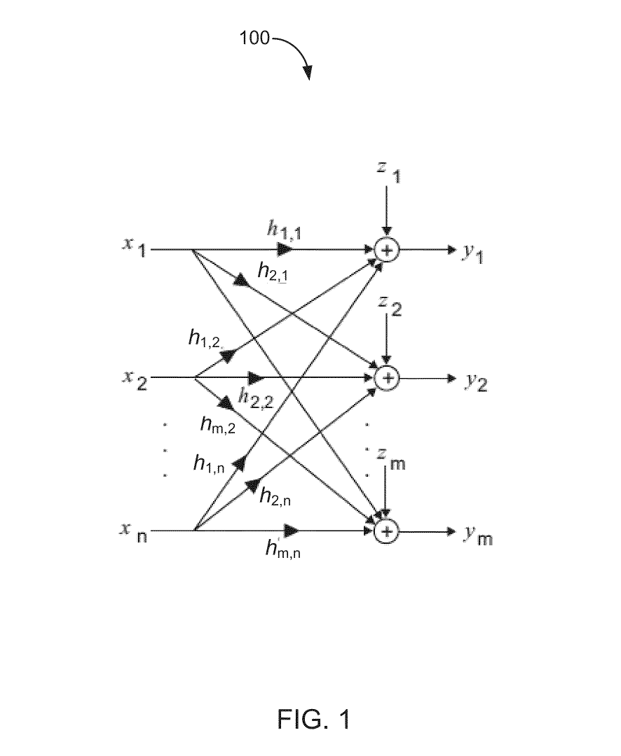

Referring now to FIG. 1, a schematic diagram of a MIMO-OFDM channel model is described. Wireless signals experience transformations such as amplitude and phase changes while traveling over air from a transmitter to a receiver. For example, a simple model for a wireless channel is:

y[t]=h·x[t]+z[t] (Eq. 1)

where t is a time index, y is the received signal, x is the transmitted signal, h is a channel gain, and z is additive noise. More complex models incorporate multipath fading, time-varying channels, multiple antennas, and so on. Coherent receivers require knowledge of the CSI (i.e., h in the simple model in Eq. 1) for successful demodulation. In addition, CSI can also be used for data rate selection, antenna selection, power control and allocation across transmit antennas, etc.

As appreciated by one skilled in the art, CSI can be obtained by using pilot sequences within a data packet. These sequences are predetermined sequences (i.e., they do not carry information) that are sent within the data packet to help the receiver estimate the CSI. For example, in the simple channel model expressed in Eq. 1, setting x=1 in the first k symbols of the data packet allows the receiver to compute:

$$\hat{h} = \frac{α}{k} {\sum }_{t = 1}^{k} y [ t ] = α \cdot h + \frac{α}{k} {\sum }_{t = 1}^{k} z [ t ] \qquad ( Eq . 2 )$$

where α is a constant chosen according to the signal to noise ratio (“SNR”) in the channel.

The 802.11n protocol allows the use of MIMO to obtain improvements in data rate and reliability. In addition, 802.11n uses OFDM modulation to convert a wideband channel into multiple narrowband channels in order to avoid inter-symbol interference (“ISI”). Accordingly, the simple model of Eq. 1 can be extended for a MIMO-OFDM channel as follows:

y[w,t]=H[w]x[w,t]+z[w,t] (Eq. 3)

where for n transmit and m receive antennas, x is an n-dimensional vector, y and z are m-dimensional vectors, H is an m×n matrix, and w is an index specifying the OFDM frequency channel.

In MIMO-OFDM systems, the CSI H is an m×n×W data structure, where W is the number of OFDM channels used in the system. For example, in 802.11n systems, W=56 for a 20 MHz bandwidth and W=114 for a 40 MHz bandwidth with channel bonding. It is appreciated that the column index of H[w] indicates the transmit antenna index, while the row index of H[w] indicates the receive antenna index. It is also appreciated that channel 100 depicted in FIG. 1 represents one of the W OFDM channels that may be used in a MIMO-OFDM system.

As described in more detail herein below for various embodiments, an m×q×W CSI data structure may be extrapolated using packets encoded with mᵢ×nᵢ×Wᵢ schemes, where q>nᵢ, and i is the packet index. That is, CSI data structures obtained from multiple packet transmissions may be extrapolated to estimate larger CSI data structures. For example, a 2×2×56 CSI data structure may be obtained by combining the CSI that is derived from two packets transmitted using a 2×1×56 configuration, as long as different transmit antennas are used to send the two packets.

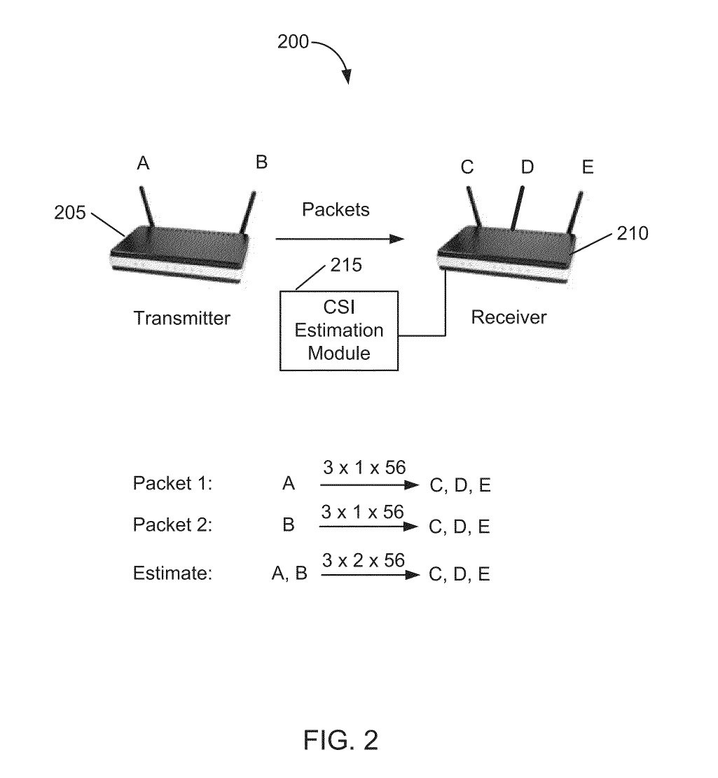

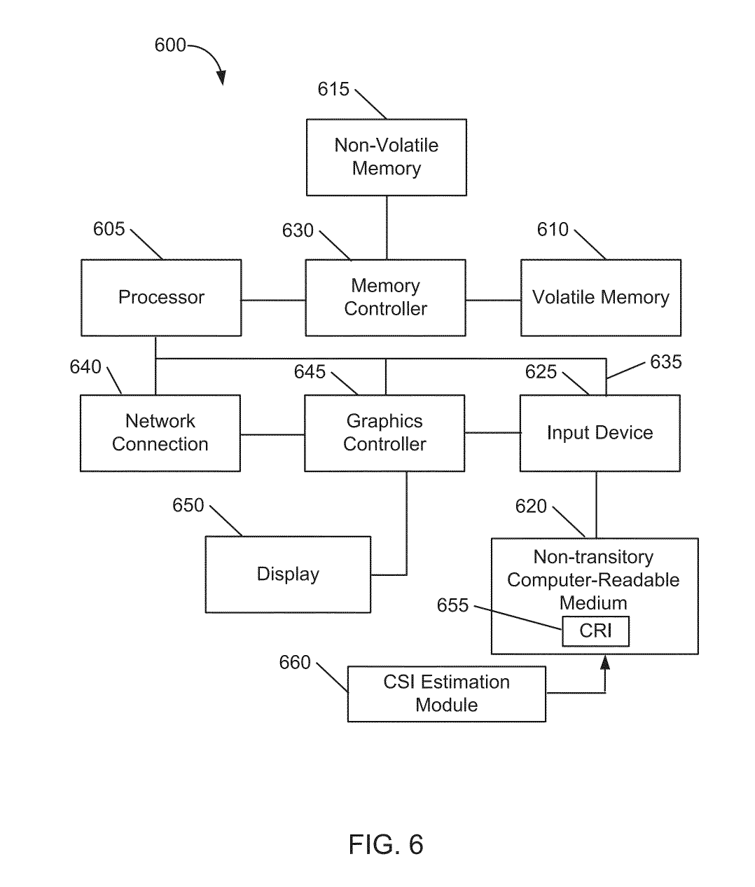

FIG. 2 illustrates an example schematic diagram for estimating a 3×2×56 CSI data structure from two packets transmitted using a 3×1×56 configuration. Channel 200 is a MIMO-OFDM channel between a transmitter 205 and a receiver 210. Transmitter 205 has two antennas—antennas A and B—and receiver 210 has three antennas—antennas C, D, and E. To properly characterize the channel 200, packets are sent from the transmitter 205 to the receiver 210. Receiver 210 estimates the CSI using a CSI estimation module 215, which may be implemented in a receiver computing system (shown in FIG. 6) within receiver 210 as hardware, software, or a combination of both.

For example, a packet 1 may be transmitted between antenna A of the transmitter 205 and antennas C, D, and E of the receiver 210, and a packet 2 may be transmitted between antenna B of the transmitter 205 and antennas C, D, and E of the receiver 210. The CSI for these two packet transmissions can be estimated by the receiver 210. These estimates, however, only provide CSI for a 3×1×56 channel configuration as only antenna A or antenna B but not both are used to transmit the packets. Successful characterization of the channel 200 requires the estimation of the complete 3×2×56 CSI data structure in the CSI estimation module 215.

According to various embodiments, instead of estimating the complete 3×2×56 CSI data structure by sending and receiving packets for every possible channel configuration, the CSI estimates obtained for the packets sent with the subset 3×1×56 configuration are extrapolated to estimate a combined 3×2×56 CSI data structure in the CSI estimation module 215. Computation of this combined, extrapolated CSI data structure requires that the packets used to formulate the CSI estimates for the computation be transmitted on different transmit antennas, e.g., antenna A for packet 1 and antenna B for packet 2.

Let Nᵢ be the set of antennas used in packet i, of size |Nᵢ|and let N be the set of transmit antennas in the combined CSI data structure. It is assumed that |M|>|Nᵢ|, for all i ∈ I, where I is the set of packets used to estimate the combined CSI. To account for the CSI for all transmit antennas in N, N ⊂ ∪ᵢ Nᵢ. That is, the estimation of a combined CSI requires that the transmitter changes the set of transmit antennas used in each packet. In addition, the set Nᵢ of transmit antennas used in packet i needs to be identified within the packet. This can be done, for example, by adding metadata in the header or payload of the packet, containing information about Nᵢ. As described in more detail herein below, the computation of a combined CSI estimate may also need to take into account the transmission power and the precoding performed at the transmitter, e.g., transmitter 205.

The CSI estimates that receivers (such as receiver 210) produce are dependent on the transmission power used for the transmitted packet. Assume that the channel gains remain constant during the transmission of two packets (e.g., packets 1 and 2 of FIG. 2) and that P₂=γP₁, where Pᵢ is the transmission power of packet i, i={1, 2} and γ is a scale factor. Then:

CSI₂=\sqrt{γ}CSI₁ (Eq. 4)

where CSIᵢ is the CSI estimate produced for packet i. If transmission power is constant, then the combined CSI estimate does not need to explicitly depend on it.

Due to regulations and practical limitations, there is a total power constraint for the transmitted signal. When the transmission spans multiple transmit antennas, assuming that the signals in the different antennas and OFDM sub-channels are statistically independent, the total transmitted power is given by:

$$P = {\sum }_{w = 1}^{W} {\sum }_{i = 1}^{n} {P}_{i} [ w ] \qquad ( Eq . 5 )$$

where Pᵢ[w] is the power in the signal transmitted in antenna i, i=1, n and frequency sub-channel w, w=1, . . . , W. In order to meet the total power constraint, Pᵢ[w] may vary for different configurations with different bandwidths or number of transmit antennas.

These power considerations have important implications for the computation of a combined CSI estimate. Referring to Eq. 3, since the transmission powers may not be known at the receiver, the CSI estimate for entry (i, j) in sub-channel w of the channel matrix H may be an estimate of H_{i,j}[w]\sqrt{Pⱼ[w]}. Since Pⱼ[w] may vary for communication schemes involving different number of transmit antennas and different transmission bandwidths, the CSI estimates used in the computation of the combined CSI estimate must be appropriately scaled.

In various embodiments, it is assumed herein that the same transmission power is used in each transmit antenna and frequency sub-channel. Let Pᵢ be an estimate generated at the receiver of the power used in each transmit antenna and frequency sub-channel for packet i. This estimate may use information provided in metadata included in the packet, information exchanged in a separate control channel, or information acquired during association. Let ƒ be a function that combines CSI derived from k packets to generate a new, possibly larger CSI structure. In order to deal with the power scaling explicitly, it is assumed that f does not perform any power scaling.

In this case, the combined CSI estimate can be computed using \sqrt{P}ƒ(CSI₁/\sqrt{P₁}, . . . , CSIₖ/\sqrt{Pₖ}), where P is the power transmitted in each antenna in each frequency sub-channel in the communication scenario in which the combined CSI estimate is to be used. For example, if the combined CSI estimate is to be used for a communication scheme that sends data over 3 transmit antennas over a 20 MHz bandwidth with equal power in each antenna and each frequency sub-channel with total transmit power P̅, then P= P̅/(56×3).

It is appreciated that in most WLAN deployments, dynamic transmission power is used in combination with rate control to reduce power consumption. Commodity hardware allows the user to choose a transmission power level. If the transmitted power closely follows the level chosen by the user, a power scaling factor can be applied to the CSI of a packet transmitted at a specific power level to estimate the CSI of a different power level. For example, if a packet sent at 7 dBm is received, the CSI for a transmission with the same antenna configuration at 5 dBm can be estimated by subtracting 1 dB (i.e., (7−5)/2 dB) from the magnitude of the original CSI.

However, practical limitations influence the power control capabilities of real transceivers. Power amplifiers are not perfectly linear, producing increasing distortion as they are driven closer to their maximum rated power. The distortion introduced by the transmitter amplifiers has a bigger impact on Modulation and Coding Schemes (“MCS”) with larger coding rates and higher order modulations. As a result, many transceivers limit the output power used for high rate MCSs through various power caps. As thus appreciated by one skilled in the art, an accurate power profiling can prevent two erroneous outcomes in the CSI estimation procedure. First, when using the CSI derived from a packet with a specific MCS to estimate the CSI of a different MCS, not being aware of the power caps might introduce estimation errors. This happens not only when combining CSI to produce estimates for a different number of streams, but also when using the CSI from a given MCS to estimate the CSI for some other MCS with the same number of streams. Additionally, this information must be considered when estimating the effect of power adaptation. For example, scaling the normal transmission power from 10 dBm to 15 dBm has no effect in the actual transmitted power (and power consumption) in MCS7 in some transceiver implementations.

Therefore, it is appreciated that to accurately apply power scaling, two pieces of information may be required: (1) the power profile for the specific hardware installed in the transmitter. This information can be hardcoded in the receiver or sent on demand by the transmitter. (2) The power level at which each packet is sent. This information can be specified explicitly by the transmitter with a specific control packet, or attached to data packets, or inferred from the packet type (e.g., beacons are generally transmitted at the lowest data rate and the highest power level).

It is also appreciated that the 802.11n standard provides an optional feature called staggered sounding by which the training sequence in the packet header is transmitted over more streams than those used in the payload of the packet. This feature enables a larger CSI structure to be estimated without risking a decoding error in the payload of the packet. However, being an optional feature, it may not be supported across various chipset vendors. In addition, it does not allow estimating CSI structures for larger bandwidth than that used for the given packet. Finally, it is not supported during beacon transmissions, hence it cannot be used in applications such as AP selection during association. When staggered sounding is supported it can be used jointly with the embodiments described herein to further reduce the number of samples required to obtain a complete knowledge of the MIMO channel.

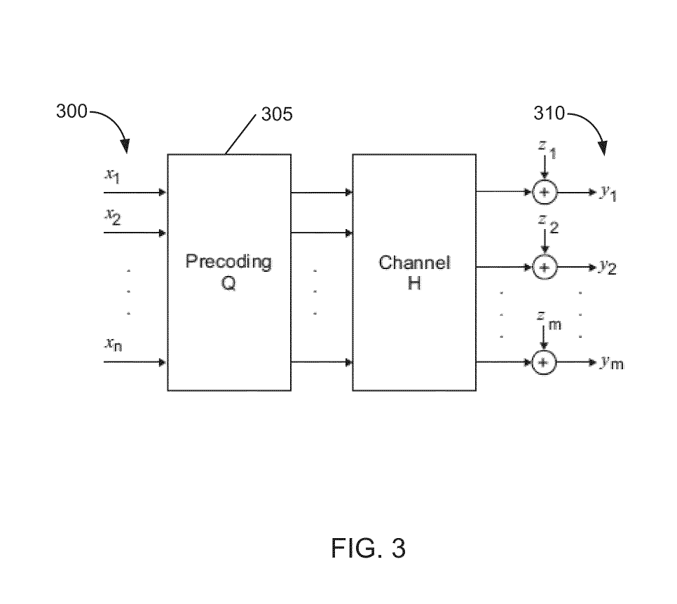

Referring now to FIG. 3, a schematic diagram of a MIMO channel using a precoding matrix Q is described. Spatial multiplexing is achieved in Eq. 3 above by sending different data streams 300 in the different entries of x. The 802.11n standard allows the use of a precoding matrix Q 305 to map x into the channel. Typically, Q 305 is a unitary matrix (i.e., Q·Q^{†}=Q^{†}·Q=I, where ^{†} denotes conjugate transpose and I is the identity matrix). As appreciated by those skilled in the art, Eq. 3 represents the so-called direct mapping mode, in which Q=I and each data stream is sent in a different transmit antenna. More generally, the received signal vector y 310 can be written as:

y[w,t]=H[w]Qx[w,t]+z[w,t] (Eq. 6)

Typically, the precoding matrix Q 305 may not need to be known at the receiver, and the channel estimation provides an estimate of H[w]Q. The computation of a combined CSI estimate therefore may require the receiver (e.g., receiver 210 in FIG. 2) to know Q 305 and post-multiply the channel estimates Ĥ[w] by Q^{†} (or Q⁻¹ if Q is not unitary) (i.e., Ĥ′=Ĥ·Q⁵⁵⁴ ).

However, Q 305 varies based on the chipset used, and may also be changed adaptively. It is assumed herein that Q 305 is known. A Q-agnostic computation of the combined CSI estimate may also be performed, albeit at a small loss in performance. In this case, the resulting CSI estimate may still be adequate for applications such as rate selection, antenna selection, power control, AP association, and so on.

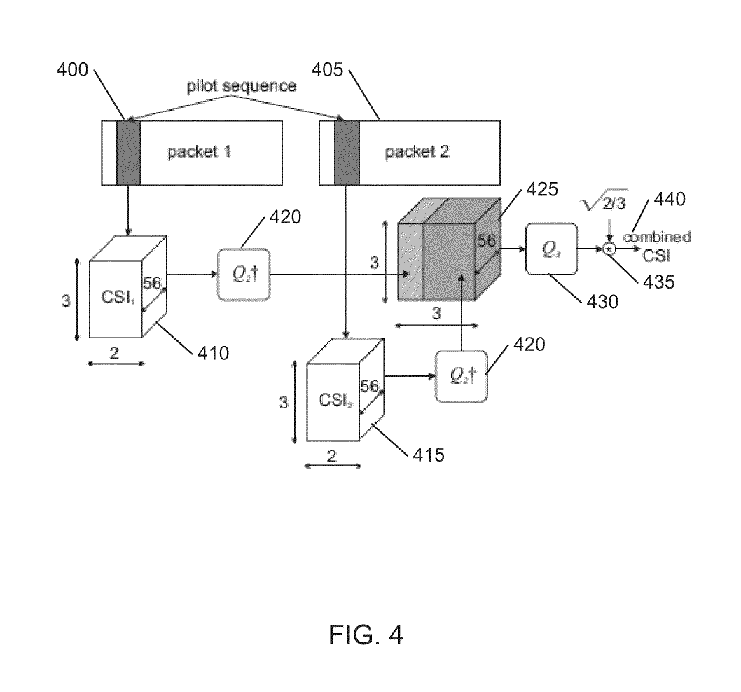

Attention is now directed at FIG. 4, which illustrates a schematic diagram of operations used to generate a combined 3×3×56 CSI estimate from two packets sent and received with a 3×2×56 channel configuration and a precoding matrix Q₂. Let packet 1 400 be transmitted with N₁={1, 2} antennas and packet 2 405 be transmitted with N₂={2, 3} antennas for a MIMO channel having N={1, 2, 3}. Similar operations may be performed for the remaining 55 sub-channels.

After successful reception of packet i, i=1, 2, the receiver (e.g., receiver 210 of FIG. 2) generates a CSI estimate for sub-channel w, Ĥᵢ[w], which may be dependent on the transmission power in each antenna and each frequency sub-channel. For example, the receiver generates the CSI estimate 410 after reception of packet 1 400 and the CSI estimate 415 after reception of packet 2 405. The CSI estimates 410 and 415 are multiplied by Q₂^{†} 420 resulting in:

\hat{H}′ᵢ[w]=\hat{H}ᵢ[w]·Q₂^{†}=[\hat{h}_{1,i}[w],\hat{h}_{2,i}[w]] (Eq. 7)

where ĥ_{i,j}[w]∈ C², i, j=1, 2.

The combined CSI estimate 440 for sub-channel w, after power scaling 435 and accounting for precoding 430, may therefore be given by:

\hat{H}₃[w]=\sqrt{2/3}·[\hat{h}_{1,1}[w],\hat{h}_{1,2}[w],\hat{h}_{2,2}[w]]·Q₃ (Eq. 8)

As appreciated by one skilled in the art, both ĥ_{2,1}[w] and ĥ_{1,2}[w] contain CSI that can be used to generate Ĥ₃[w]. However, only ĥ_{1,2}[w] is used in the combined CSI estimate in Eq. 8 due to the fact that wireless channels often experience variations over time and the most recent CSI is often the most suitable to make future estimates.

It is appreciated that more general combining functions can be used to balance the effects of channel variations and channel estimation errors due to, e.g., noise. One such example is:

\hat{H}₃[w]=\sqrt{2/3}·[\hat{h}_{1,1}[w], (β\hat{h}_{1,2}[w]+(1−β)\hat{h}_{2,1}[w]), \hat{h}_{2,2}[w]]·Q₃ (Eq. 9)

where β ∈ [0,1] is some constant chosen appropriately and Q₃ is the precoding matrix used for the 3×3×56 channel configuration. It is also appreciated that the 3×3×56 channel configuration of the combined CSI estimate 440 is used herein for purposes of illustration; a combined CSI estimate may be extrapolated for multiple channel state configurations using packets of subset configurations, for example a combined CSI estimate may be derived for any m×q×W channel configuration using CSI estimates obtained from packets received with an m×nᵢ×W channel configuration, where q>nᵢ. Note that the number of antennas nᵢ used to transmit each packet i may be different from packet to packet. For example, a combined CSI estimate for a 3×3×56 channel configuration may be generated from a packet transmitted with a 3×1×56 configuration and a packet transmitted with a 3×2×56 configuration.

It is also appreciated that in practical systems, the transmitter and receiver clocks may drift with respect to one another in frequency or phase. As a result, the CSI estimates obtained from a packet may have a random phase offset that may vary from packet to packet. For example, the CSI estimate Ĥ obtained from a packet can be expressed as Ĥ=e^{jθ} H, where H is the true channel gain matrix and θ ∈ [0,2π) is a random phase introduced by the phase offset between the transmitter and receiver clock asynchrony. The random phase offset is not important for successful packet reception as long as it remains constant for the duration of the packet.

However, when combining CSI estimates as described above, the random phase difference between the packets used in the estimates needs to be compensated for whenever possible. When combining CSI structures corresponding to schemes that reuse one or more transmit antennas, the column(s) in H corresponding to the common antenna(s) can be used to derive the difference between the phase offsets between the CSI structures, and compensate for them. For example, assume that only one receive antenna is used, let Ĥ₁=[ĥ₁₁,ĥ₁₂]=e^{jθ}_{₁}[h₁,h₂] be a CSI estimate obtained from a packet transmitted using transmit antennas 1 and 2, and let Ĥ₂=[ĥ₂₁,ĥ₂₂]=e^{jθ}_{₂}[h₂,h₃] be a CSI estimate obtained from a packet transmitted using transmit antennas 2 and 3. The phase difference α can be computed as follows:

α=phase(\hat{h}₁₂)−phase(\hat{h}₂₁) (Eq. 10)

The combined CSI estimate may then be determined as:

Ĥ=[ĥ₁₁,e^{jα}ĥ₂₁,e^{jα}ĥ₂₂]=e^{jθ}_{₁}[h₁,h₂,h₃] (Eq. 11)

Note that in cases where there is no common transmit antenna(s) in the multiple CSI structures Ĥ₁ and Ĥ₂ that are combined to form the estimate in Eq. 11, the random phase differences cannot be compensated. The resulting CSI estimates may have some random phase offsets which may be acceptable in most applications where CSI estimates may be combined, such as rate selection, antenna selection, power control, AP selection, and so on.

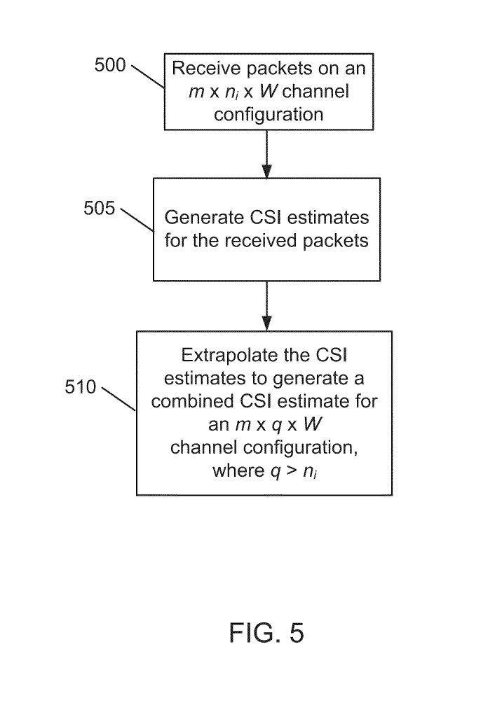

The operations described above are shown in a flowchart illustrated in FIG. 5. First, packets are received for an m×nᵢ×W channel configuration, where i denotes the packet index (500). Next, CSI estimates are generated for the received packets (505). Lastly, the CSI estimates generated for the received packets are extrapolated to form a combined CSI estimate for an m×q×W channel configuration, where q>nᵢ (510). The combined CSI estimate is formed by adjusting the CSI estimates for the received packets to account for the channel precoding matrix and for the power transmitted in each antenna as described above with reference to Eq. 8.

Advantageously, extrapolating a combined CSI estimate for an m×q×W channel configuration using CSI estimates obtained from packets received with an m×nᵢ×W channel configuration can save time and bandwidth by not requiring the transmission and sampling of a sounding packet for the various MIMO channel states. Further, the combined CSI estimate can be used to improve the performance of various network algorithms such as rate adaptation, beamforming, and association control, among others.

As described above, the combined CSI estimate may be computed in a CSI estimation module (e.g., CSI estimation module 215 in FIG. 2) implemented in hardware, software, or a combination of both. Referring now to FIG. 6, a block diagram of an example receiver computing system for estimating a combined CSI estimate according to the present disclosure is described. The receiver computing system 600 (e.g., a desktop computer, a laptop, a multi-core processing system, etc.) can include a processor 605 and memory resources, such as, for example, the volatile memory 610 and/or the non-volatile memory 615, for executing instructions stored in a tangible non-transitory medium (e.g., volatile memory 610, non-volatile memory 615, and/or computer readable medium 620) and/or an application specific integrated circuit (“ASIC”) including logic configured to perform various examples of the present disclosure.

A machine (e.g., a computing device) can include and/or receive a tangible non-transitory computer-readable medium 620 storing a set of computer-readable instructions (e.g., software) via an input device 625. As used herein, the processor 605 can include one or a plurality of processors such as in a parallel processing system. The memory can include memory addressable by the processor 605 for execution of computer readable instructions. The computer readable medium 620 can include volatile and/or non-volatile memory such as a random access memory (“RAM”), magnetic memory such as a hard disk, floppy disk, and/or tape memory, a solid state drive (“SSD”), flash memory, phase change memory, and so on. In some embodiments, the non-volatile memory 615 can be a local or remote database including a plurality of physical non-volatile memory devices.

The processor 605 can control the overall operation of the receiver computing system 600. The processor 605 can be connected to a memory controller 630, which can read and/or write data from and/or to volatile memory 610 (e.g., RAM). The memory controller 630 can include an ASIC and/or a processor with its own memory resources (e.g., volatile and/or non-volatile memory). The volatile memory 610 can include one or a plurality of memory modules (e.g., chips). The processor 605 can be connected to a bus 635 to provide communication between the processor 605, the network connection 640, and other portions of the receiver computing system 600. The non-volatile memory 615 can provide persistent data storage for the receiver computing system 600. Further, the graphics controller 645 can connect to a display 650.

Each receiver computing system 600 can include a computing device including control circuitry such as a processor, a state machine, ASIC, controller, and/or similar machine. Each receiver computing system 600 can also include one or more VMs (not shown), and have a hypervisor to manage the VMs. As used herein, the indefinite articles “a” and/or “an” can indicate one or more than one of the named object. Thus, for example, “a processor” can include one processor or more than one processor, such as in a parallel processing arrangement.

The control circuitry can have a structure that provides a given functionality, and/or execute computer-readable instructions that are stored on a non-transitory computer-readable medium (e.g., the non-transitory computer-readable medium 620). The non-transitory computer-readable medium 620 can be integral, or communicatively coupled, to a computing device, in either a wired or wireless manner. For example, the non-transitory computer-readable medium 620 can be an internal memory, a portable memory, a portable disk, or a memory located internal to another computing resource (e.g., enabling the computer-readable instructions to be downloaded over the Internet).

The non-transitory computer-readable medium 620 can have computer-readable instructions 655 stored thereon that are executed by the processor 605 to implement a CSI estimation module 660 according to the present disclosure. The non-transitory computer-readable medium 620, as used herein, can include volatile and/or non-volatile memory. Volatile memory can include memory that depends upon power to store information, such as various types of dynamic random access memory (“DRAM”), among others. Non-volatile memory can include memory that does not depend upon power to store information. Examples of non-volatile memory can include solid state media such as flash memory, EEPROM, and phase change random access memory (“PCRAM”), among others. The non-transitory computer-readable medium 620 can include optical discs, digital video discs (“DVD”), Blu-Ray Discs, compact discs (“CD”), laser discs, and magnetic media such as tape drives, floppy discs, and hard drives, solid state media such as flash memory, EEPROM, PCRAM, as well as any other type of computer-readable media.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein. For example, it is appreciated that the present disclosure is not limited to a particular computing system configuration, such as computing system 600.

Those of skill in the art would further appreciate that the various illustrative modules and steps described in connection with the embodiments disclosed herein may be implemented as electronic hardware, computer software, or combinations of both. For example, the example steps of FIG. 5 may be implemented using software modules, hardware modules or components, or a combination of software and hardware modules or components. Thus, in one embodiment, one or more of the example steps of FIG. 5 may comprise hardware modules or components. In another embodiment, one or more of the steps of FIG. 5 may comprise software code stored on a computer readable storage medium, which is executable by a processor.

To clearly illustrate this interchangeability of hardware and software, various illustrative components, blocks, modules, and steps have been described above generally in terms of their functionality (e.g., the CSI estimation module 215). Whether such functionality is implemented as hardware or software depends upon the particular application and design constraints imposed on the overall system. Those skilled in the art may implement the described functionality in varying ways for each particular application, but such implementation decisions should not be interpreted as causing a departure from the scope of the present disclosure.

What is claimed is:

1. A method for extrapolating channel state information (“CSI”) estimates from multiple packets sent over different antennas to generate a combined CSI estimate for a MIMO-OFDM system, the method comprising:
receiving packets on m×nᵢ×W channel configurations, wherein m is a number of receive antennas used to receive the packets, nᵢ is a number of transmit antennas used to transmit a packet indexed with i, and W is a number of OFDM channels in the MIMO-OFDM system;
generating CSI estimates for the received packets; and
extrapolating the CSI estimates for the received packets to generate a combined CSI estimate for an m×q×W channel configuration, wherein q>nᵢ for all i.

2. The method of claim 1, wherein the received packets comprise a set I of received packets and wherein a packet i in the set I is transmitted using a set Nᵢ of antennas, wherein |N|>|Nᵢ|, for all i ∈ I, N denotes a set of transmit antennas for the combined CSI estimate, and “| |” denotes set cardinality.

3. The method of claim 2, wherein the set Nᵢ of antennas used to transmit a packet i in the set I of received packets is different than a set Nⱼ of antennas used to transmit a packet j in the set I of received packets, for all i and j in I, i≠j.

4. The method of claim 2, wherein the set Nᵢ of antennas used to transmit a packet i in the set I of received packets is identified with metadata in the packet i.

5. The method of claim 1, further comprising adjusting the CSI estimates for the received packets based on a precoding matrix used for the m×nᵢ×W channel configuration and further adjusting these estimates by a power scaling.

6. The method of claim 1, wherein extrapolating the CSI estimates for the received packets to generate a combined CSI estimate comprises adjusting the combined CSI estimate by a precoding matrix used for the m×q×W channel configuration.

7. The method of claim 6, wherein adjusting the combined CSI estimate by a precoding matrix used for the m×q×W channel configuration comprises post-multiplying the combined CSI estimate by the precoding matrix used for the m×q×W channel configuration.

8. A receiver for use in a MIMO-OFDM system to extrapolate channel state information (“CSI”) estimates from multiple packets sent over different antennas to generate a combined CSI estimate, the receiver comprising:
a CSI estimation module to generate a combined CSI estimate for an m×q×W channel configuration by extrapolating CSI estimates generated from packets received with m×nᵢ×W channel configurations, wherein nᵢ<|N| is a number of transmit antennas used to transmit the packet with index i, N is a set of transmit antennas, m≦|M| is a number of receive antennas used to receive the packets, M is a set of receive antennas, W is a number of OFDM channels, and q>nᵢ for all i.

9. The receiver of claim 8, wherein the received packets comprise a set I of received packets and wherein a packet i in the set I is transmitted using a set Nᵢ of antennas, wherein |N|>|Nᵢ|, for all i ∈ I, N denotes a set of transmit antennas for the combined CSI estimate, and “| |” denotes set cardinality.

10. The receiver of claim 9, wherein the set Nᵢ of antennas used to transmit a packet i in the set I of received packets is different than a set Nⱼ of antennas used to transmit a packet j in the set I of received packets, for all i and j in I, i≠j.

11. The receiver of claim 9, wherein the set Nᵢ of antennas used to transmit a packet i in the set I of received packets is identified within the packet i.

12. The receiver of claim 8, wherein the CSI estimates generated from packets received with the m×nᵢ×W channel configurations are adjusted based on a precoding matrix used for the m×nᵢ×W channel configuration, and further adjusted by a power scaling, where i indicates the packet index.

13. The receiver of claim 8, wherein the combined CSI estimate is adjusted by a precoding matrix used for the m×q×W channel configuration.

14. A channel state information (“CSI)” estimation module for use with a receiver in a MIMO-OFDM system to extrapolate channel state information (“CSI”) estimates from multiple packets sent over different antennas to generate a combined CSI estimate, the CSI estimation module comprising instructions to:
receive packets on m×nᵢ×W channel configurations, wherein m is a number of receive antennas used to receive the packets, nᵢ is a number of transmit antennas used to transmit a packet indexed by i, and W is a number of OFDM channels in the MIMO-OFDM system;
generate CSI estimates for the received packets; and
extrapolate the CSI estimates for the received packets to generate a combined CSI estimate for an m×q×W channel configuration, wherein q>nᵢ for all i.

15. The CSI estimation module of claim 14, wherein the received packets comprise a set I of received packets and wherein a packet i in the set I is transmitted using a set Nᵢ of antennas, wherein |N|>|Nᵢ|, for all i ∈ I, N denotes a set of transmit antennas for the combined CSI estimate, and “| |” denotes set cardinality.

16. The CSI estimation module of claim 14, wherein the set Nᵢ of antennas used to transmit a packet i in the set I of received packets is different than a set Nⱼ of antennas used to transmit a packet j in the set I of received packets, for all i and j in I, i≠j.

17. The CSI estimation module of claim 15, wherein the set Nᵢ of antennas used to transmit a packet i in the set I of received packets is identified within the packet i.

18. The CSI estimation module of claim 14, wherein the CSI estimates generated from packets received with the m×nᵢ×W channel configuration are adjusted based on a precoding matrix used for the m×nᵢ×W channel configuration, and further adjusted by a power scaling.

19. The CSI estimation module of claim 14, wherein the combined CSI estimate is adjusted by a precoding matrix used for the m×q×W channel configuration.
